(19) United States
(12) Patent Application Publication
(10) Pub. No.: US 2008/0112318 A1
(43) Pub. Date: May 15, 2008

(54) Traffic shaping and scheduling in a network

(76) Inventors: Rejean Groleau, Ville St-Laurent (CA); Robert Buchnajzer, Montreal (CA)

Correspondence Address: HOLLAND & KNIGHT LLP, 10 ST. JAMES AVENUE, 11th Floor, BOSTON, MA, 02116-3889, US

(21) Appl. No.: 11/598,599

(22) Filed: Nov. 13, 2006

(51) Int. Cl. H04L 12/56

(52) U.S. Cl. 370/230.1

(57) ABSTRACT

Methods and apparatus, including computer program products, for traffic shaping and scheduling in a network. A computer-implemented method includes receiving a data packet Lₙ from a network at a rate R_{N}, metering and coloring the packet Lₙ using two-rate three coloring marking (trTCM), labeling and enqueuing the packet Lₙ to a scheduler's queue, enqueuing the packet Lₙ in a deferral queue if the packet Lₙ is non-conformant and head-of-line (HOL), to delay the packet Lₙ an amount of time to become conformant, up-dating the conformity parameters upon dequeuing of the packet Lₙ using its label, determining the conformance of the next HOL packet Lₙ₊₁ using its label and the conformity parameters and, if packet Lₙ₊₁ is non-conformant, enqueuing the packet Lₙ₊₁ in a deferral queue to delay its scheduling an amount of time to become conformant.

### BACKGROUND

The present invention relates to data processing by digital computer, and more particularly to traffic shaping and scheduling in a network.

Traffic management in a network is concerned with controlling and allocating bandwidth, reducing delay, and minimizing congestion on networks. Traffic management typically encompasses the management of network capacity and analyzing performance. A basic idea is to manage network resources efficiently and give client/subscribers the bandwidth and service levels they need. For carrier networks, these levels are negotiated in Service Level Agreements (SLAs). At the same time, clients and subscribers traffic should be managed to ensure that it does not use bandwidth that would affect service levels of other users. This often requires admittance controls (i.e., only admit traffic that is allowed and no excess that would affect other service levels) and policing (i.e., monitor traffic on an ongoing basis).

### SUMMARY

The present invention provides methods and apparatus, including computer program products, for traffic shaping and scheduling in a network.

In one aspect, the invention features a method including receiving a data packet Lₙ from a network at a rate R_{N}, metering and coloring the packet Lₙ using two-rate three coloring marking (trTCM), labeling in a traffic shaper the packet Lₙ with an arrival time, a burst flag and a shaping delay, with respect to a peak information rate (PIR) and a burst size, enqueuing the packet Lₙ to a scheduler's queue and computing in a scheduler the conformity parameters of the packet Lₙ. If the packet Lₙ is non-conformant, it is delayed by the proper amount of time to become conform ant to its SLA.

In embodiments, the method can include dequeuing the packet Lₙ from the scheduler's queue to an Internet Protocol (IP) bandwidth-limited link according to the packet Lₙ's Quality of Service (QoS) parameters.

Processing the packet Lₙ in the traffic shaper can include computing a shaping delay Δ(sh)ₙ, using the packet length Lₙ and the Peak Information Rate PIR, recording a timestamp TS giving the arrival time A(sh)ₙ of the packet and can include the setting of a burst flag F^{Burst}ₙ when detecting the presence of a burst that exceeds the tokens available in the trTCM algorithm. After processing the packet Lₙ, the shaper forwards the packet Lₙ in the scheduler's queue with the labels [Lₙ, F^{Burst}ₙ, A(sh)ₙ, Δ(sh)ₙ].

Enqueuing the packet Lₙ in the scheduler's queue can include enqueuing the packet with labels [Lₙ, F^{Burst}ₙ, A(sh)ₙ, Δ(sh)ₙ], determining if the packet is Head-of-Line (HOL), if the packet is HOL and F^{Burst}ₙ is 0, computing a priority for the packet and placing the packet in a priority queue, and if the packet is HOL and F^{Burst}ₙ is 1, placing the packet Lₙ in a deferral queue with deadline D(sh)ₙ₋₁=t_{BurstStart}+Δt^{cumul}.

Processing the deferral queue can include, at a beginning of every frame k of duration T_{frame}, obtaining the present timestamp TSₖ and, for all entries in the deferral queue satisfying D(sh)ₙ₋₁<TSₖ+T_{fr}, deleting the entry in the deferral queue, computing the priority, and inserting in the priority queue of the scheduler.

Scheduling the HOL packet Lₙ from the scheduler's queue can include, dequeing the packet and computing the conformity parameters by computing the earliest shaper departure time for the packet Lₙ represented by D(sh)ₙ₋₁=t_{BurstStart}+Δt^{cumul}, which is the earliest time the previous packet Lₙ₋₁ should leave the shaper, and by comparing it to the arrival time A(sh)ₙ of the packet Lₙ The result of the comparison is used to compute the conformity parameters t_{BurstStart} and Δt^{cumul}. After dequeuing packet Lₙ, if another packet Lₙ₊₁ is present in the queue and becomes HOL, the state of its burst flag F^{Burst}ₙ₊₁ is checked. If set, its earliest shaper departure time is computed as D(sh)ₙ=t_{BurstStart}+Δt^{cumul}, and if D(sh)ₙ<TSₖ+T_{frame} is not true, put the packet Lₙ₊₁ in the deferral queue with deadline D(sh)ₙ. Otherwise, the priority is computed and the packet inserted in the priority queue.

The scheduler's queue can include random-early-discard (RED) queue management. trTCM can color the packet Lₙ according to a committed information rate (CIR) and a peak information rate (PIR). CIR can be a data rate negotiated with a carrier. PIR can be an upper limit that a traffic information rate may not exceed.

The invention can be implemented to realize one or more of the following advantages.

A traffic shaper operates in conjunction with a traffic scheduler to apply a delay to packets exceeding a certain rate in a network. This increases an effective rate of Transmission Control Protocol (TCP) flows as well as limiting users to the rates they subscribed to.

The method uses a metering/coloring/shaping/scheduling scheme that includes metering and coloring packets using a two-rate three-color marker (e.g., trTCM) process, enqueuing the packets in the scheduler's queue, on a per-flow basis, and scheduling the packets using a rate-proportional process. When the queue size reaches a watermark, some packets are dropped using, for example, a random-early-discard process (e.g., Random Early Discard (RED)/Weighted Random Early Discard (WRED)). By applying the conformity parameters only to the HOL packet of the scheduler, the method does not add unnecessary delay due to discarded packets.

A traffic shaper and a packet scheduler are implemented using the same queue to enforce an upper-limit on the bandwidth provided by the scheduler. The use of a single queue makes implementation simple while introducing limited traffic distortion and keeping priority scheduling intact with its proven delay bounds.

The method uses a trTCM metering/coloring scheme referred to as a two rate three color marker scheme to meter the bursting of a source. Colored packets are tagged with a burst flag, an arrival time and a shaping delay and put in a scheduler queue. Upon becoming HOL in the queue, an earliest shaper departure time of the packet is compared to a present time. If it is too early, the packet is delayed until its earliest departure time is reached. Only then is a priority (for example, virtual time) computed. By applying the conformity parameters only to the HOL packet of the scheduler, the method takes into account the time spent by the packet in the scheduler's queue. The method will not introduce an unnecessary shaping delay if the delay in the scheduler's queue is larger than the conformity parameters.

The method acts as a token-bucket where bursts of short duration above the PIR are allowed without delay, but larger bursts are delayed to conform to the SLA.

The method optimizes operator revenue by insuring that the user gets only the rates paid for and the user sees the same behavior of the system, independent of the latter's business.

The method insures traffic conformance to its SLA, which is one prerequisite for proper operation of the priority scheduler.

One implementation of the invention provides all of the above advantages while giving the functionality of a standard structure referred to herein as the reference model.

Other features and advantages of the invention are apparent from the following description, and from the claims.

### BRIEF DESCRIPTION OF THE DRAWINGS

FIG. 1 is a block diagram of an exemplary Internet Protocol (IP)-based network.

FIG. 2 is a block diagram of the reference model emulated by the method. It shows a path followed by a packet.

FIG. 3 is a diagram of processing instants for a delayed packet in the reference model emulated by the method.

FIG. 4 is block diagram of the meter/coloring/shaper/scheduler modules.

FIG. 5 is a diagram of processing instants for a delayed packet in the method.

FIG. 6 is a flow diagram of a shaper process.

FIG. 7 is a flow diagram of a scheduler enqueue process.

FIG. 8 is a flow diagram of a scheduler dequeue process.

Like reference numbers and designations in the various drawings indicate like elements.

### DETAILED DESCRIPTION

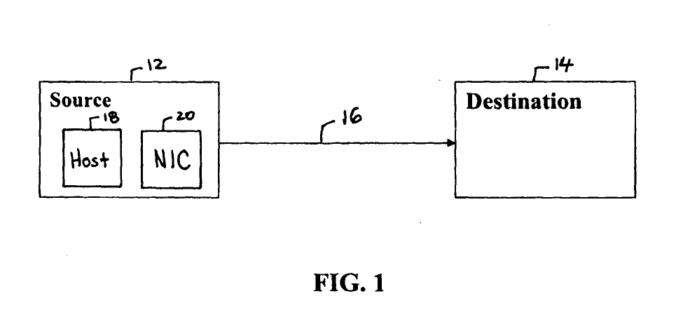

As shown in FIG. 1, an exemplary Internet Protocol (IP)-based network 10 includes a source 12 having a traffic shaper scheduler incorporated therein for controlling traffic bandwidth and a destination 14. An IP bandwidth-limited link 16 is utilized to connect the source 12 to the destination 14. In one particular example, the IP bandwidth-limited link 16 can represent an air link in a wireless broadband network, i.e., a radio-frequency portion of a circuit between the source 12 and the destination 14.

The source 12 includes a host system 18 and a network interface card (NIC) 20. The host system 18 generates data that is forwarded to the NIC 20. The NIC 20 transforms the data into IP packets and outputs it over the IP bandwidth-limited link 16. The rate of IP packets sent to IP bandwidth-limited link 16 is controlled and managed by the NIC 20 to avoid congestion. In one particular example, the traffic shaper scheduler is implemented in a medium access control (MAC) layer of the NIC 20.

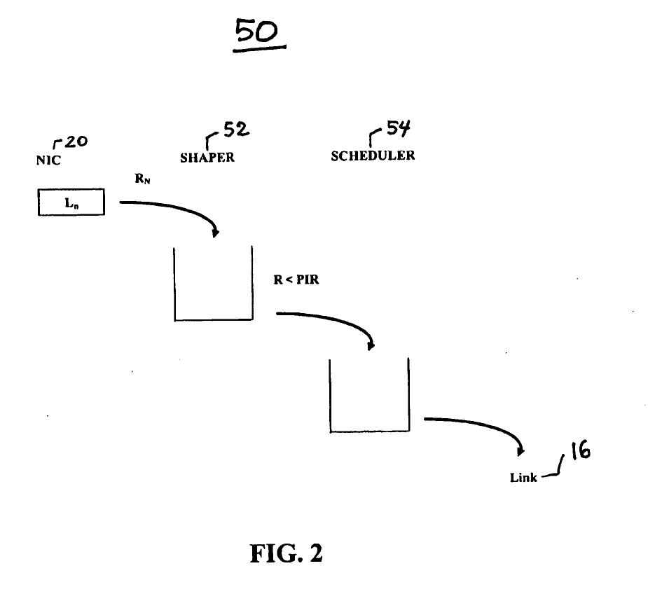

As shown in FIG. 2, for the reference model emulated by the traffic shaper scheduler, a path 50 followed by a packet Lₙ incorporating the traffic shaper scheduler includes the packet Lₙ coming from the host system 18 at a rate Rₙ, e.g., 100 Mbps for a 100 BaseT Ethernet link. A shaper portion 52 of the traffic shaper scheduler verifies conformity of packet Lₙ with respect to a Peak Information Rate (PIR) value. If the packet Lₙ is conformant, the packet goes immediately in the scheduler's queue 54. If the packet Lₙ is non-conformant, the packet Lₙ is enqueued in the shaper's queue and delayed by an appropriate amount of time to become conformant. When the packet Lₙ is released from the shaper 52, the packet Lₙ enters the scheduler queue 54 at a maximum rate of PIR. The scheduler 54 puts the packet Lₙ on the IP bandwidth-limited link 16 according to its Quality of Service (QoS) parameters. Within the scheduler queue 54, for example, a random-early-discard scheme is implemented.

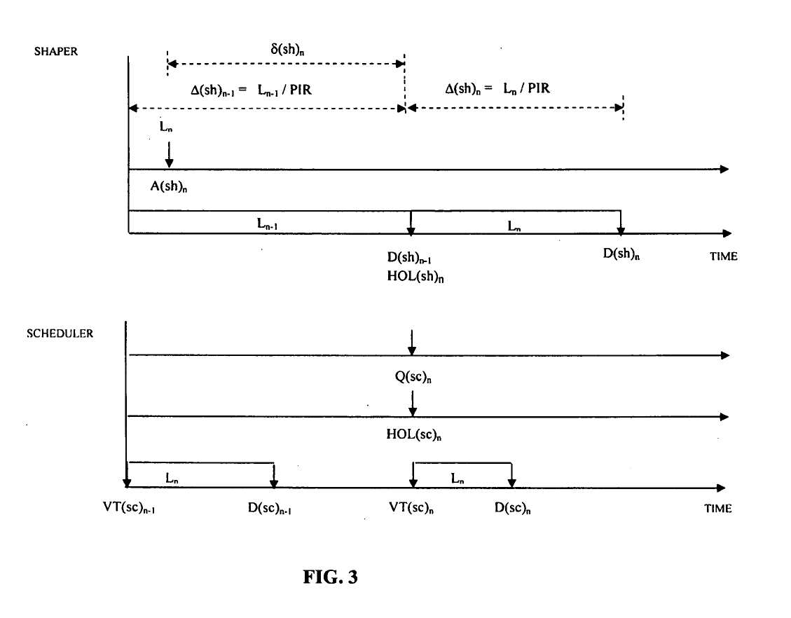

In FIG. 3, processing instants for a delayed packet Lₙ are shown for the reference model, wherein the various time instants are:

A(sh)ₙ: the arrival time at the shaper's queue.

HOL(sh)ₙ: the arrival time at the HOL of the shaper's queue.

D(sh)ₙ: the departure time from the shaper's queue.

Q(sc)ₙ: the arrival time at the scheduler's queue.

HOL(sc)ₙ: the arrival time at the HOL of the scheduler's queue.

VT(sc)ₙ: the time at which the virtual time of a rate-proportional scheduling algorithm is computed for the packet.

D(sc)ₙ: the departure time from the scheduler's queue.

The delays are:

δ(sh)ₙ: the shaping delay incurred by packet Lₙ.

Δ(sh)ₙ: the shaping delay due to packet Lₙ.

Packet Lₙ arrives in the shaper queue at time instant A(sh)ₙ. At time D(sh)ₙ₋₁, which is the conformance departure time of the previous packet Lₙ₋₁, packet Lₙ reaches the HOL of the shaper queue (HOL(sh)ₙ).

The arrival of packet Lₙ in the scheduler's queue, at Q(sc)ₙ, corresponds to the arrival time of the packet at the HOL of the shaper's queue, HOL(sh)ₙ, instead of its departure time, D(sh)ₙ. It is favored when the first packet of a burst arrives, it is not delayed by the shaper, but processed immediately by the scheduler. It is favored when a flow sends at a lower rate than PIR and should not experience any shaping delay. This also has the added advantage of minimizing the use of a “deferral mechanism” described below.

The following relationships hold: Q(sc)ₙ=HOL(sh)ₙ; VT(sc)ₙ=HOL(sc)ₙ.

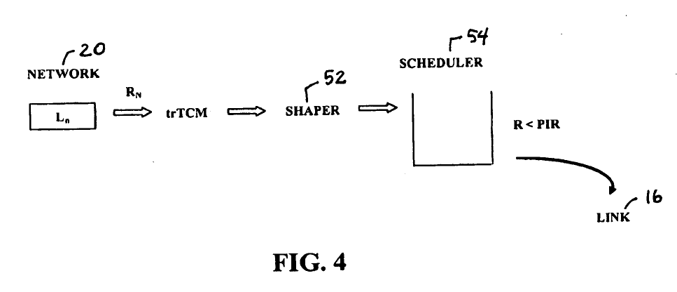

In FIG. 4, a meter/coloring/shaper/scheduler implementation of the traffic shaper scheduler is shown. It gives the functionality of the reference model shown in FIG. 2 while giving the advantages mentioned previously. The packet Lₙ traverses the trTCM and the shaper modules experiencing only the processing delay. Enqueing occurs at the scheduler. The coloring by the trTCM module pertains to network traffic, i.e. the traffic before shaping. So the packet-dropping in the scheduler can still use the red-colored packets as input.

The traffic shaper scheduler uses the following for the metering/coloring/shaping/scheduling. Packets are metered and colored (e.g., green, yellow or red) using a “two-rate three-color marker” (trTCM) scheme, such as RFC 2698. The shaper labels packet Lₙ. Packets are then enqueued in the scheduler's queue, on a per-flow basis, and scheduled using a weighted fair queuing rate-proportional method. When the queue size reaches a watermark, some packets are dropped using, for example, a random-early-discard method (e.g., RED/WRED). When packet Lₙ is dequeued by the scheduler, the conformity parameters of the shaper are computed. When a packet Lₙ₊₁ becomes HOL, its labels and the conformity parameters are used to determine if the packets needs to be delayed.

The trTCM scheme colors packets according to a Committed Information Rate (CIR) and a PIR, without affecting the packet arrival time into the scheduler. The weighted fair queuing rate-proportional method guarantees a minimum rate ρᵢ^{min} for the flow, based on the CIR, the PIR and an oversubscription ratio (OSR). The scheduler computes the priority of packets only when they reach the HOL and when they equal or exceed their earliest departure time.

The traffic shaper scheduler uses a single queue per flow. In order to keep the rate-proportional method intact (with its proven delay-bounds), the functionalities of the traffic shaper and of the scheduler are kept separate as in the reference model, while keeping the queue management in the scheduler only.

A rate-limiting goal can be obtained by configuring the trTCM method to drop out-of-profile (e.g., red) packets. However, this has a negative impact on the effective rate of TCP flows.

Here, the traffic shaper scheduler upper-limits the traffic rate by delaying non-conformant packets. This replaces an immediate packet dropping of the trTCM meter by a deferral of the packet, which smoothes a burst. Dropping only occurs when the scheduler queue reaches a watermark due to congestion or to a source exceeding its burst allocation.

In the traffic shaper, coloring controls the conformance to the burstiness. When the flow has an amount of red-colored packets below a certain threshold, the flow is given the maximum IP bandwidth-limited link 16 available. When the red-coloring goes above the threshold, the packets wait until they become conformant. The traffic shaper enables this Boolean behavior of the shaper as a function of the coloring.

The increased delay of some packets due to shaping does not affect delay-insensitive traffic like TCP. For delay-sensitive traffic, the shaping delay can be turned off by setting the burst flag F^{Burst}ₙ to zero at all time.

The traffic-shaper can use finite-precision (integer) mathematics, and can have a resolution of about +/−one frame period. This can negatively affect the delay and jitter performance of delay-sensitive flows and therefore the traffic-shaper is used for delay-insensitive traffic, such as nrtPS and BE flows in IEEE 802.16.

By delaying the packets exceeding the PIR of the flow, the traffic-shaper reduces burstiness. This favors the performance of TCP flows. Without the traffic-shaper, the scheduler 54 allocates as much bandwidth as possible to the flow. TCP then increases its rate until packets are dropped by the scheduler 54. With the traffic-shaper, the packets are delayed and TCP will “sense” the limited bandwidth without losing packets (unless the bursts are very large).

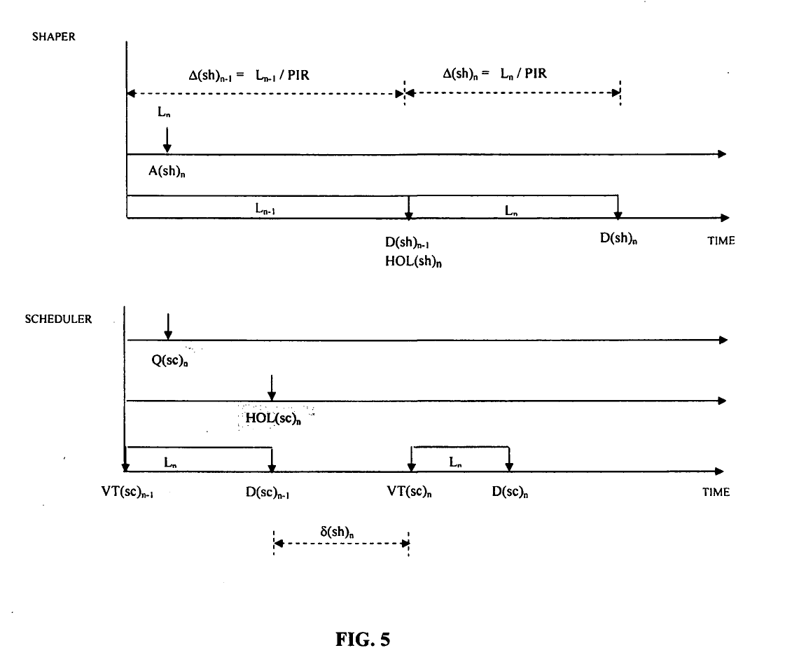

FIG. 5 shows the processing instants for the delayed packet Lₙ using an implementation of the traffic shaper scheduler. These instants can be compared to the ones in the reference model shown in FIG. 3. The traffic shaper scheduler computes, for packet Lₙ, what would be its departure time from the shaper's queue (D(sh)ₙ₋₁) in the reference model. The method is implemented using three variables, i.e., t_{BurstStart}, Δt^{cumul}, and F^{Burst}ₙ. t_{BurstStart} represents a time instant at which a burst of data starts to arrive from the network. Δt^{cumul} represents cumulative shaping delay during a burst. F^{Burst}ₙ represents a flag indicating if Lₙ is part of a burst or not, as determined by a threshold on the number of red-colored packets from the trTCM module.

In contrast to the reference model, the traffic shaper enqueues the packet in the scheduler queue immediately (Q(sc)ₙ). When a packet Lₙ₋₁ departs from the scheduler (D(sc)ₙ₋₁), the conformity parameters t_{BurstStart} and Δt^{cumul} are updated using the arrival time A(sh)ₙ₋₁ of the packet and its earliest shaper departure time D(sh)ₙ₋₂. When packet Lₙ becomes HOL in the scheduler queue (HOL(sc)ₙ), if its burst flag F^{Burst}ₙ is set and its earliest shaper departure time D(sh)ₙ₋₁ is equal to or larger than TSₖ+T_{frame}, then packet Lₙ is inserted in the deferral queue where it is kept until its deadline D(sh)ₙ₋₁ expires. Otherwise, the priority is computed and the packet inserted in the priority queue.

If an HOL packet incurs a shaping delay, a deferral mechanism is added to the scheduler to insure that its priority computation and its entry in the priority queue occur after this delay.

A shaper process 100 operates as follows. The arrival time A(sh)ₙ, the shaping delay Δ(sh)ₙ and the state of the burst flag F^{Burst}ₙ for the packet Lₙ are determined. The packet is labeled with these variables and put in the scheduler's queue.

The label of the packet is used when the packet Lₙ becomes the HOL to determine its conformance. It is also be used when the packet is dequeued by the scheduler to compute the conformance parameters for the next HOL packet Lₙ₊₁.

To dynamically turn the shaper ON and OFF, a function “f_{Color}( )” of the coloring is computed and compared to a threshold. The switching is controlled by the flag F^{Burst}ₙ.

The shaper calls the enqueue function of the scheduler with the following arguments: Lₙ (designates all the arguments not pertaining to the method), A(sh)ₙ₋, Δ(sh)ₙ and F^{Burst}ₙ.

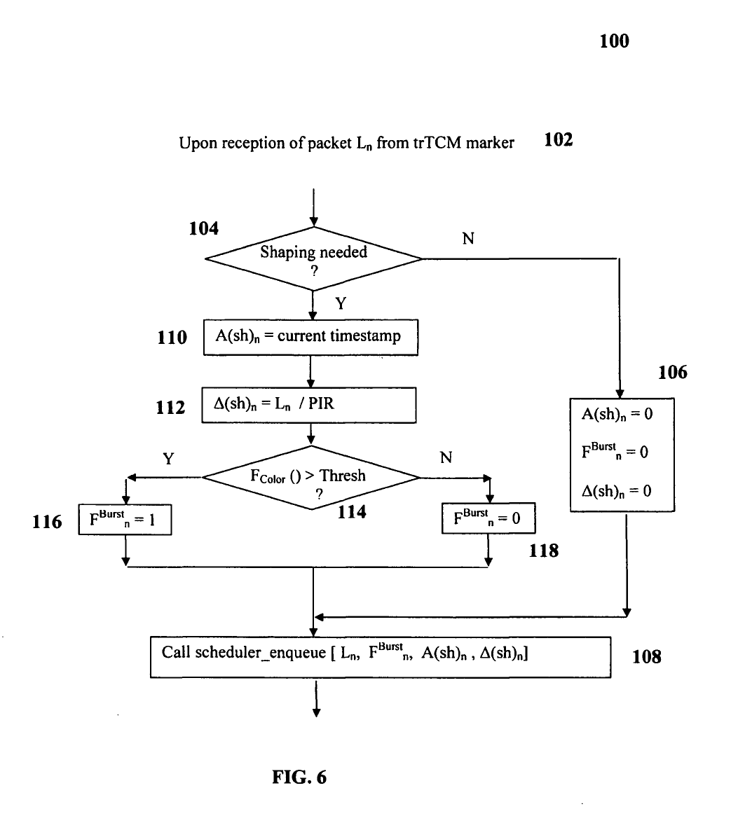

As shown in FIG. 6, the shaper process 100 includes receiving (102) a packet Lₙ from the trTCM marker. Process 100 determines (104) whether shaping is needed. If shaping is not needed, process 100 sets (106) the arrival time, the shaping delay and the burst flag to zero. Process 100 then calls (108) a scheduler enqueue process 200, described below.

If shaping is needed, process 100 sets (110) the arrival time at the shaper's queue to the current time stamp, computes (112) the shaping delay due to packet Lₙ and determines (114) whether the computed function f_{Color}( ) is greater than a threshold. If greater than the threshold, process 100 sets (116) the flow burst flag to one. If less than the threshold, process 100 sets (118) the flow burst flag to zero.

Process 100 calls (108) a scheduler enqueue process 200, described below.

The scheduler enqueue process 200 operates as follows. At reception of packet Lₙ from the shaper, the scheduler enqueues the packet with the labels (Lₙ, F^{Burst}ₙ, A(sh)ₙ, Δ(sh)ₙ) and checks if the packet is HOL. If the packet is HOL and F^{Burst}ₙ is 0, the scheduler processes the packet, i.e., computes the priority for the packet, and puts the packet in the priority queue. If the packet is HOL and F^{Burst}ₙ is 1, the scheduler computes the deadline D(sh)ₙ₋₁ and places the packet in the deferral queue, fully explained below.

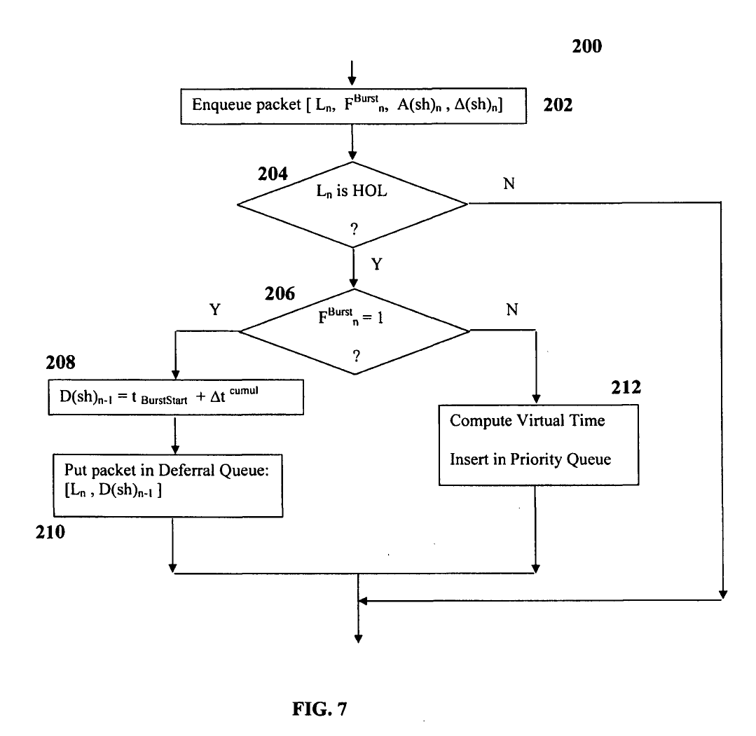

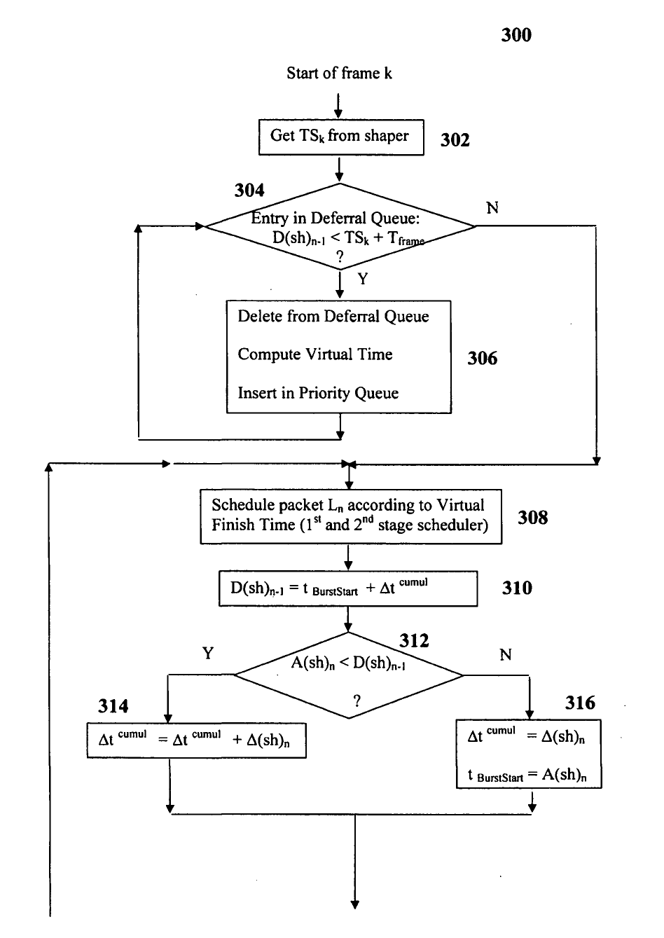

As shown in FIG. 7, the scheduler enqueue process 200 includes receiving (202) packet Lₙ, the flag indicating if Lₙ is part of a burst or not, the arrival time of the packet and the shaping delay due to the packet Lₙ. Process 200 determines (204) whether packet Lₙ is at the HOL. If it is at the HOL, process 200 determines (206) whether the flag indicates that packet Lₙ is part of the burst. If part of the burst, process 200 computes (208) the deadline D(sh)ₙ₋₁ at which packet Lₙ can leave the deferral queue and places (210) the packet in the deferral queue with its deadline. If not part of the burst, process 200 computes (212) the priority, for example virtual time, and inserts the packet into the priority queue.

The deferral queue is added to the scheduler to delay packets exceeding their SLA and enables the scheduler to implement a “sleep” function that has the duration of the shaping delay. When a packet Lₙ comes at the HOL of the scheduler's queue, if the calculated departure time of the previous packet D(sh)ₙ₋₁ exceeds the present time, packet Lₙ is put on the deferral queue. In this case, the priority of the packet is not calculated yet. Each entry in the deferral queue corresponds to a HOL packet of a flow. Therefore, for example, in IEEE 802.16, there would be at most one entry per nrtPS and BE flow in the deferral queue.

A scheduler dequeue process 300 operates as follows. When the scheduler is invoked to build frame k, the following functions are added. At the beginning of every frame k, the scheduler gets from the shaper the present timestamp TSₖ, and processes the deferral queue as follows. For all entries in the deferral queue satisfying D(sh)ₙ₋₁<TSₖ+T_{frame}, delete the entry in the deferral queue, compute the priority, and insert in the priority queue.

When a packet Lₙ is dequeued (i.e., has been scheduled according to its priority), the conformity parameters are updated by computing the earliest shaper departure time for the HOL packet Lₙ represented by D(sh)ₙ₋₁=t_{BurstStart}+Δt^{cumul}, which is the time the previous packet Lₙ₋₁ should leave the shaper, and by comparing it to the arrival time A(sh)ₙ of the packet Lₙ The result of the comparison is used to compute the conformity parameters t_{BurstStart} and Δt^{cumul}. If a new packet Lₙ₊₁ becomes HOL, additional processing is added to insure that, when the burst flag is set, the previous packet's departure time D(sh)ₙ from the shaper does not exceed the end of the present frame, i.e., “D(sh)ₙ<TSₖ+T_{frame}”, where T_{frame} is the frame period. If D(sh)ₙ exceeds the end of the present frame, packet Lₙ₊₁ will be inserted in the deferral queue and delayed by a time sufficient to make it conformant.

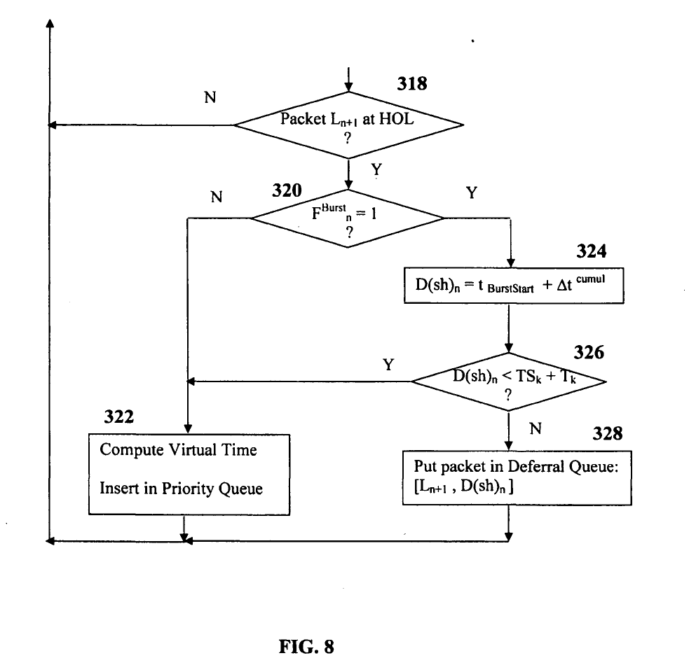

As shown in FIG. 8, the scheduler dequeue process 300 includes, at a start of some frame k, getting (302) the present timestamp from the shaper. Process 300 processes (304) the deferral queue for all entries where the departure time is less than the sum of the present timestamp and the frame period.

For all such entry, process 300 deletes (306) the packet from the deferral queue, computes the priority, and inserts the packet into the priority queue.

Process 300 schedules (308) the packet Lₙ according to its priority.

When packet Lₙ is dequeued, process 300 computes (310) the earliest shaper departure time for the HOL packet Lₙ represented by D(sh)ₙ₋₁=t_{BurstStart}+Δt^{cumul}, which is time the previous packet Lₙ₋₁ should leave the shaper. Process 300 determines (312) if the packet arrival time A(sh)ₙ is smaller than the computed delay D(sh)ₙ₋₁. If the arrival time is smaller, process 300 adds (314) the shaping delay Δ(sh)ₙ to the cumulative variable Δt^{cumul}, since the packet Lₙ is part of a burst. If the arrival time is not smaller, process 300 sets (316) the start of burst variable t_{BurstStart} equal to the arrival time A(sh)ₙ and sets the cumulative variable Δt^{cumul} equal to the shaping delay Δ(sh)ₙ, since the packet Lₙ is not part of a burst.

Process 300 determines (318) if there is another packet Lₙ₊₁ at the HOL. If not, process 300 schedules (308). If so, process 300 determines (320) whether the packet is part of the burst.

If it is not part of the burst, process 300 computes (322) the priority, inserts the packet into the priority queue, and schedules (308).

If the packet is part of the burst, process 300 computes (324) the earliest shaper departure time for the HOL packet Lₙ₊₁ represented by D(sh)ₙ=t_{BurstStart}+Δt^{cumul}, which is time the previous packet Lₙ should leave the shaper and determines (326) whether the departure time from the shaper's queue of the previous packet is less than the sum of the present timestamp and the frame period. If less, process 300 computes (322) and schedules (308). If greater than or equal too, process 300 places (328) the packet in the deferral queue and schedules (308).

Embodiments of the invention can be implemented in digital electronic circuitry, or in computer hardware, firmware, software, or in combinations of them. Embodiments of the invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of embodiments of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

The foregoing description of several methods and an embodiment of the invention have been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

It is to be understood that the foregoing description is intended to illustrate and not to limit the scope of the invention, which is defined by the scope of the appended claims. Other embodiments are within the scope of the following claims.

What is claimed is:

1. A computer-implemented method comprising:
receiving a data packet Lₙ from a network at a rate R_{N};
metering and coloring the packet Lₙ using two-rate three coloring marking (trTCM);
labeling the packet Lₙ with an arrival time, a shaping delay and a burst flag;
enqueuing the packet Lₙ to a scheduler's queue; and
enqueuing the packet Lₙ in a deferral queue if the packet Lₙ is head-of-line (HOL) and non-conformant, to delay the packet Lₙ an amount of time to become conformant.

2. The computer-implemented method of claim 1 further comprising:
dequeuing the packet Lₙ from the scheduler's queue to a packet-based bandwidth-limited link according to the packet Lₙ's Quality of Service (QoS) parameters; and
verifying conformity of the packet Lₙ₊₁ in a traffic shaper using a peak information rate (PIR).

3. The computer-implemented method of claim 1 wherein labeling the packet Lₙ in the traffic shaper comprises:
setting an arrival time A(sh)ₙ for packet Lₙ using a timestamp TS indicating the arrival time of the packet;
computing the shaping delay Δ(sh)ₙ using the packet size Lₙ and the Peak Information Rate (PIR); and
determining the packet burst flag F^{Burst}ₙ using the trTCM metering and a threshold.

4. The computer-implemented method of claim 1 wherein enqueuing the packet Lₙ in the scheduler's queue comprises:
enqueuing the packet with labels (Lₙ, F^{Burst}ₙ, A(sh)ₙ, Δ(sh)ₙ);
determining if the packet is Head-of-Line (HOL);
if the packet is HOL and F^{Burst}ₙ is 0, computing a priority for the packet and placing the packet in a priority queue; and
if the packet is HOL and F^{Burst}ₙ is 1, placing the packet in a deferral queue.

5. The computer-implemented method of claim 2 wherein dequeuing the packet Lₙ from the scheduler's queue comprises:
at a beginning of a frame k, obtaining the present timestamp TSₖ;
for all entries in the deferral queue satisfying D(sh)ₙ₋₁<TSₖ+T_{frame}, deleting the entry in the deferral queue, computing the priority, and inserting in the priority queue.

6. The computer-implemented method of claim 2 wherein computing the conformity parameters of the traffic shaper when packet Lₙ is dequeued comprises:
computing a departure time D(sh)ₙ₋₁ for the previous packet Lₙ₋₁ using the conformity parameters t_{BurstStart} and Δt^{cumul};
detecting a start of a burst when a flow exceeds its allowed burstiness and recording the start in a variable t_{BurstStart}; and
recording a cumulative shaping delay during the burst in a variable Δt^{cumul}.

7. The computer-implemented method of claim 2 wherein scheduling packet Lₙ₊₁ comprises:
determining if a packet Lₙ₊₁ is at the HOL;
if a packet Lₙ₊₁ is HOL, determining if its earliest shaper departure time D(sh)ₙ=t_{BurstStart}+Δt^{cumul} is smaller than TSₖ+T_{frame};
if smaller, computing the priority and inserting in the priority queue; and
if larger, inserting in the deferral queue with deadline D(sh)ₙ.

8. The computer-implemented method of claim 1 wherein the scheduler's queue comprises random-early-discard (RED) queue management.

9. The computer-implemented method of claim 1 wherein trTCM colors the packet Lₙ according to a committed information rate (CIR) and a peak information rate (PIR).

10. The computer-implemented method of claim 7 wherein the CIR is a data rate negotiated with a carrier.

11. The computer-implemented method of claim 7 wherein the PIR is an upper limit that a traffic information rate may not exceed.

12. A computer program product, tangibly embodied in an information carrier, for network packet management, the computer program product being operable to cause data processing apparatus to:
receive a data packet Lₙ from a network at a rate R_{N};
meter and color the packet Lₙ using two-rate three coloring marking (trTCM);
enqueue the packet Lₙ to a scheduler's queue with a set of labels;
enqueue the packet Lₙ in a deferral queue if the packet Lₙ is non-conformant and head-of-line (HOL), to delay the packet Lₙ an amount of time to become conformant;
update, at dequeue of the packet Lₙ, conformity parameters using the shaping delay due to packet Lₙ;
verify conformity, using a peak information rate (PIR), of packet Lₙ₊₁ when it becomes head-of-line; and
place in a deferral queue the non-conformant and head-of-line packet Lₙ₊₁ to delay the packet an amount of time to become conformant.

13. The computer program product of claim 12 further operable to cause data processing apparatus to:
dequeue the packet Lₙ from the scheduler's queue to an Internet Protocol (IP) bandwidth-limited link according to the packet Lₙ's Quality of Service (QoS) parameters.

14. The computer program product of claims 12 wherein verifying the conformity of the packet Lₙ₊₁ in the traffic shaper comprises:
using, at the dequeue of the previous packet Lₙ, the arrival time A(sh)ₙ in the label of the packet Lₙ to update the conformity parameters t_{BurstStart} and Δt^{cumul};
detecting a start of a burst which exceeds its allowed burstiness and recording the start in a variable t_{BurstStart};
recording a cumulative shaping delay during the burst in a variable Δt^{cumul}, the calculated departure time for the packet Lₙ represented by D(sh)ₙ=t_{BurstStart}+Δt^{cumul};
computing a departure time D(sh)ₙ for packet Lₙ using the conformity parameters; and
using the burst flag F^{Burst}ₙ₊₁ of packet Lₙ₊₁ and the earliest shaper departure time D(sh)ₙ of the previous packet Lₙ to determine the conformity of packet Lₙ₊₁.
